(19) United States
(12) Patent Application Publication
(10) Pub. No.: US 2017/0359164 A1
(43) Pub. Date: Dec. 14, 2017

(54) PHASE-SHIFTER CIRCUIT AND METHOD OF GENERATING A PHASE-SHIFTED FORM OF A REFERENCE TIMING SIGNAL

(71) Applicant: MediaTek Singapore Pte. Ltd., SOLARIS (SG)

(72) Inventors: Spyridon Vlachogiannatos, Kent (GB); Venkata Murali Nandigam, West Malling (GB)

(73) Assignee: MediaTek Singapore Pte. Ltd.

(21) Appl. No.: 15/588,990

(22) Filed: May 8, 2017

Related U.S. Application Data
(63) Continuation-in-part of application No. 15/176,905, filed on Jun. 8, 2016, now Pat. No. 9,705,664.
(60) Provisional application No. 62/383,703, filed on Sep. 6, 2016.

(51) Int. Cl. H04L 7/06; H04L 25/02; H04L 7/00

(52) U.S. Cl. CPC H04L 7/06; H04L 7/0037; H04L 7/0079; H04L 25/022

(57) ABSTRACT

A phase-shifter circuit arranged to receive a reference timing signal and to output a phase-shifted form of the reference timing signal. The phase-shifter circuit comprises a delay circuit arranged to receive the reference timing signal and a delay control signal, and to delay transitions within the reference timing signal to generate the phase-shifted form of the reference timing signal, wherein the amount of delay applied by the delay circuit to the transitions within the reference timing signal is controllable by the delay control signal. The phase-shifter circuit further comprises a delay control circuit arranged to receive a re-timed signal comprising transitions re-timed to transitions of the phase-shifted form of the reference timing signal output by the phase-shifter circuit, and to generate the delay control signal for the delay circuit based on the received re-timed signal.

### FIELD OF THE INVENTION

The field of this invention relates to a phase-shifter circuit and method generating a phase-shifted form of a reference timing signal.

### BACKGROUND OF THE INVENTION

In the field of radio frequency (RF) transceivers, even-numbered frequency dividers are used within synthesizers to generate quadrature (I/Q) local oscillator (LO) signals. FIG. 1 illustrates an example of such a conventional synthesizer 100. The synthesizer 100 consists of one or more 1/M frequency divider circuits 110, 120. Each frequency divider circuit 110, 120 comprises M flip-flops 112, 114, 116 coupled in a loop whereby the outputs of each flip-flop 112, 114, 116 are coupled to respective inputs of the next flip-flop in the loop, with the exception of the M^{th} flip-flop 116 whose outputs are inversely coupled to the inputs of the first flip-flop 112 such that the non-inverted output of the M^{th} flip-flop 116 is coupled to the inverted input of the first flip-flop 112 whilst the inverted output of the M^{th} flip-flop 116 is coupled to the non-inverted input of the first flip-flop 112.

A timing signal 125 to be divided is provided to the clock inputs of each of the flip-flops 112, 114, 116. In this manner, a state transition resulting from the inverse coupling of the M^{th} flip-flop 116 to the first flip-flop 112 is shifted along the flip-flop loop by one flip-flop each clock cycle. As a result, each flip-flop output generates an oscillating signal having a frequency equal to 1/M the frequency of the timing signal 125, with the respective signal being phase-shifted relative to the signal of the preceding flip-flop by 180/M.

It is known to use even-numbered frequency dividers to generate quadrature LO signals, since generating the required 90° phase-shifted quadrature signals using an even-numbered frequency divider is relatively straightforward. In an even-numbered frequency divider, M is divisible by two. If M is divisible by two, then 90° phase-shifted signals may simply be obtained from, for example, the M^{th} flip-flop and the (M^{th}/2) flip-flop. For example, in a ½ frequency divider, the signal output by the first flip-flop 112 will be phase-shifted with respect to the M^{th} (2^{nd}) flip-flop 116 by 180/2, i.e. by 90°. Thus, the 90° phase-shifted quadrature signals may be obtained from an output of the 2^{nd} (M^{th}) flip-flop 116 and the 1^{st} (M^{th}/2) flip-flop 112.

Conversely, if M is not divisible by two (e.g. M=3), a second frequency divider circuit 120 comprising flip-flops arranged to receive timing signal 125 at their clock inputs may be used to generate frequency-divided signals. For example, where M=3, the frequency-divided signals generated by the second frequency divider circuit 120 will have flip flop outputs phase-shifted by 180°/3, i.e. by 60° with respect to one another.

Thus, even-numbered frequency division lends itself to generating 90° phase-shifted signals, and thus it is relatively straightforward to generate quadrature frequency-divided signals using even-numbered frequency divider circuits.

Due to the increased number of frequency bands in cellular telecommunications standards, it is becoming increasingly desirable to be able to utilise odd-numbered division for generating local oscillator signals in order to reduce the required frequency range of the synthesizer circuits. However, unlike for even-numbered frequency division, a 90° phase-shift is not directly achievable with odd-numbered frequency division. For example, where M=3, the flip-flop generated signals will be phase-shifted with respect to one another by 180°/3, i.e. by 60°.

Thus, a need exists for an improved odd-numbered frequency divider circuit and method of operation therefor from which 90° phase-shifted quadrature signals are able to be generated.

In addition, in many applications the accuracy of the timing of the rising and falling edges of high frequency signals output by frequency divider circuits is important, within any errors introducing phase noise within the signals. Accordingly, there is a further need for ensuring the accuracy of the rising and falling edges of the frequency divider circuit output signals.

### SUMMARY OF THE INVENTION

Accordingly, the invention seeks to mitigate, alleviate or eliminate one or more of the above mentioned disadvantages singly or in any combination. Aspects of the invention provide a phase shifter circuit, a radio frequency transceiver with a synthesizer and a method therefor as described in the appended claims.

According to a first aspect of the invention, there is provided a phase-shifter circuit arranged to receive a reference timing signal and to output at least one phase-shifted form of the reference timing signal. The phase-shifter circuit comprises at least one delay circuit arranged to receive the reference timing signal and a delay control signal, and to delay transitions within the reference timing signal to generate the at least one phase-shifted form of the reference timing signal, wherein the amount of delay applied by the delay circuit to the transitions within the reference timing signal is controllable by the delay control signal. The phase-shifter circuit further comprises at least one delay control circuit arranged to receive at least one re-timed signal comprising transitions re-timed to transitions of the phase-shifted form of the reference timing signal output by the phase-shifter circuit, and to generate the delay control signal for the at least one delay circuit based at least partly on the received at least one re-timed signal.

Advantageously, and as described in greater detail below, by generating the delay control signal based on the re-timed signals in this manner, the delay applied by the delay circuit to the transitions within the reference timing signal can be controlled to compensate for transition timing errors within the re-timed signal(s), and thus to ensure the accuracy of the timing of the transitions within the re-timed signals themselves

According to some optional embodiments, the at least one delay control circuit may be arranged to receive a first re-timed signal comprising a first set of transitions comprising one of rising and falling transitions and a second set of transitions comprising the other of rising and falling transitions, wherein the first set of transitions of the first re-timed signal are re-timed to transitions of the reference timing signal and the second set of transitions of the first re-timed signal are re-timed to rising transitions of the phase-shifted form of the reference timing signal, receive a second re-timed signal comprising a first set of transitions comprising one of rising and falling transitions and a second set of transitions comprising the other of rising and falling transitions, wherein the first set of transitions of the second re-timed signal are re-timed to transitions of the reference timing signal and the second set of transitions of the second re-timed signal are re-timed to falling transitions of the phase-shifted form of the reference timing signal, and generate the at least one delay control signal based at least partly on the first and second re-timed signals.

According to some optional embodiments, the first set of transitions of the first re-timed signal and the first set of transitions of the second re-timed signal may be re-timed to the same transitions of the reference timing signal.

According to some optional embodiments, the at least one delay control circuit may comprise an operational amplifier arranged to receive a voltage signal representative of the first re-timed signal at a first input thereof and a voltage signal representative of the second re-timed signal at a second input thereof, and the at least one delay control circuit is arranged to generate the delay control signal for the at least one delay circuit based at least partly on a voltage signal at an output of the operational amplifier.

According to some optional embodiments, the at least one delay control circuit may further comprise a first input filter circuit arranged to receive the first re-timed signal and to generate the voltage signal representative of the first re-timed signal at the first input of the operational amplifier, a second input filter circuit arranged to receive the second re-timed signal and to generate the voltage signal representative of the second re-timed signal at the second input of the operational amplifier, and a capacitance coupled between the output of the operational amplifier and a reference voltage node.

According to some optional embodiments, the phase-shifter circuit may be arranged to receive a differential reference timing signal and to output a phase-shifted form of the differential reference timing signal. As such, the phase-shifter circuit may comprise a first delay circuit arranged to receive a first differential component of the reference timing signal and a first delay control signal, and to delay transitions within the first differential component of the reference timing signal to generate a first differential component of the phase-shifted form of the reference timing signal, wherein the amount of delay applied by the first delay circuit to the transitions within the first differential component of the reference timing signal is controllable by the first delay control signal, a second delay circuit arranged to receive a second differential component of the reference timing signal and a second delay control signal, and to delay transitions within the second differential component of the reference timing signal to generate a second differential component of the phase-shifted form of the reference timing signal, wherein the amount of delay applied by the second delay circuit to the transitions within the second differential component of the reference timing signal is controllable by the second delay control signal, a first delay control circuit arranged to receive at least one re-timed signal comprising transitions re-timed to transitions of the first differential component of the phase-shifted form of the reference timing signal output by the first phase-shifter circuit, and to generate the first delay control signal for the first delay circuit based at least partly on the at least one re-timed signal received thereby, and a second delay control circuit arranged to receive at least one re-timed signal comprising transitions re-timed to transitions of the second differential component of the phase-shifted form of the reference timing signal output by the second phase-shifter circuit, and to generate the second delay control signal for the second delay circuit based at least partly on the at least one re-timed signal received thereby.

According to some optional embodiments, the first delay control circuit may be arranged to receive a first re-timed signal comprising a first set of transitions re-timed to transitions of the first differential component of the reference timing signal and a second set of transitions re-timed to rising transitions of the first differential component of the phase-shifted form of the reference timing signal, receive a second re-timed signal comprising a first set of transitions re-timed to transitions of the first differential component of the reference timing signal and a second set of transitions re-timed to falling transitions of the first differential component of the phase-shifted form of the reference timing signal, and generate the first delay control signal based at least partly on the first and second re-timed signals. Additionally, the second delay control circuit may be arranged to receive a third re-timed signal comprising a first set of transitions re-timed to transitions of the second differential component of the reference timing signal and a second set of transitions re-timed to rising transitions of the second differential component of the phase-shifted form of the reference timing signal, receive a fourth re-timed signal comprising a first set of transitions re-timed to transitions of the second differential component of the reference timing signal and a second set of transitions re-timed to falling transitions of the second differential component of the phase-shifted form of the reference timing signal, and generate the second delay control signal based at least partly on the third and fourth re-timed signals.

According to some optional embodiments, the first set of transitions of the first re-timed signal and the first set of transitions of the second re-timed signal may be re-timed to the same transitions of the first differential component of the reference timing signal, and the first set of transitions of the third re-timed signal and the first set of transitions of the fourth re-timed signal may be re-timed to the same transitions of the second differential component of the reference timing signal.

According to some optional embodiments, the first re-timed signal may comprise a positive component, Q, of a differential quadrature timing signal, the second re-timing signal may comprise a negative component, I_{b}, of a corresponding differential in-phase timing signal, the third re-timing signal may comprise a positive component, I, of the differential in-phase timing signal, and the fourth re-timing signal may comprise a negative component, Q_{b}, of the differential quadrature timing signal.

According to some optional embodiments, the phase-shifter circuit may be arranged to output at least one 90° phase-shifted form of the reference timing signal.

According to a second aspect of the invention, there is provided method of generating a phase-shifted form of a reference timing signal. The method comprises receiving the reference timing signal, receiving a delay control signal, and delaying transitions within the reference timing signal to generate the phase-shifted form of the reference timing signal, wherein the amount of delay applied to the transitions within the reference timing signal is controllable by the delay control signal. The method further comprises receiving at least one re-timed signal comprising transitions re-timed to transitions of the phase-shifted form of the reference timing signal, and generating the delay control signal for the at least one delay circuit based at least partly on the received at least one re-timed signal.

According to a third aspect of the invention, there is provided a synthesizer arranged to generate at least one timing signal. The synthesizer comprises at least one odd-numbered frequency divider circuit arranged to receive a reference timing signal and to output at least one frequency-divided signal having a frequency equal to 1/M times the frequency of the reference timing signal, where M is an odd-numbered integer. The synthesizer further comprises a phase-shifter circuit according to the first aspect of the invention arranged to receive the reference timing signal and to output a 90° phase-shifted form of the reference timing signal, and a re-timing circuit arranged to receive the at least one frequency-divided signal, receive the 90° phase-shifted form of the reference timing signal, and re-time a set of transitions of the frequency-divided signal to be temporally aligned to transitions of the 90° phase-shifted form of the reference timing signal to generate the at least one timing signal comprising the re-timed transitions of the frequency-divided signal.

These and other aspects of the invention will be apparent from, and elucidated with reference to, the embodiments described hereinafter.

### BRIEF DESCRIPTION OF THE DRAWINGS

Further details, aspects and embodiments of the invention will be described, by way of example only, with reference to the drawings. Elements in the figures are illustrated for simplicity and clarity and have not necessarily been drawn to scale. Like reference numerals have been included in the respective drawings to ease understanding.

FIG. 1 illustrates an example of a conventional synthesizer.

FIG. 2 illustrates a simplified block diagram of a radio unit with a radio frequency (RF) transceiver.

FIG. 3 illustrates a timing diagram showing various timing signals.

FIG. 4 schematically illustrates a simplified example of a part of a synthesizer.

FIG. 5 illustrates a simplified circuit diagram of an example of a part of a re-timing circuit.

FIG. 6 illustrates a timing diagram illustrating the timing of signals within the example re-timing circuit illustrated in FIG. 5.

FIG. 7 schematically illustrates an alternative example of a part of a synthesizer.

FIG. 8 illustrates a timing diagram showing various signals within the synthesizer circuit of FIG. 7.

FIG. 9 illustrates a simplified flowchart of a method of generating a timing signal from a reference timing signal.

FIG. 10 illustrates a simplified flowchart of a method of generating a timing signal from a reference timing signal.

FIG. 11 illustrates a simplified circuit diagram of an example of a delay-locked loop circuit for generating a 90° phase-shifted form of a received timing signal.

FIG. 12 illustrates a simplified circuit diagram of an example embodiment of a phase-shifter circuit for generating a phase-shifted form of a received timing signal.

FIG. 13 illustrates a timing diagram showing the various differential signals within FIG. 12.

FIGS. 14 and 15 illustrate simplified flowcharts of an example of a method of generating a phase-shifted form of a reference timing signal.

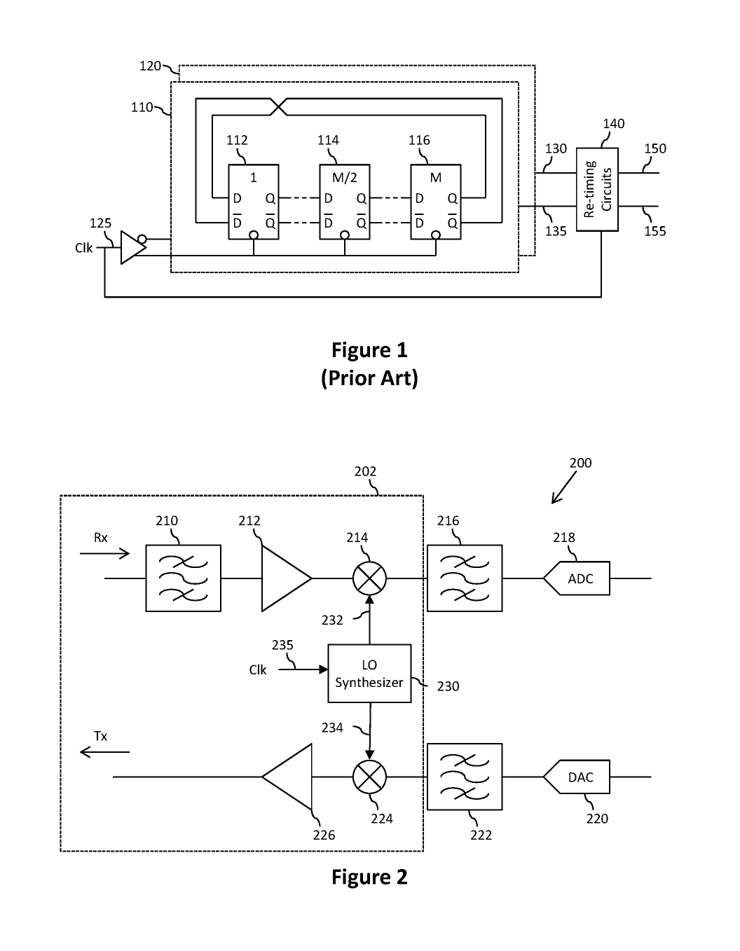

### DETAILED DESCRIPTION

Examples of the invention will be described in terms of a synthesizer for use within a radio frequency transceiver. However, it will be appreciated by a skilled artisan that the inventive concept herein described may be embodied in any type of device requiring the generation of a timing signal.

In accordance with some example embodiments of the invention, there is provided a synthesizer arranged to generate a timing signal. The synthesizer comprises an odd-numbered frequency divider circuit arranged to receive a reference timing signal and to output at least one frequency-divided signal having a frequency equal to 1/M times the frequency of the reference timing signal, where M is an odd-numbered integer. A 90° phase-shift component is arranged to receive the reference timing signal and to output a 90° phase-shifted form of the reference timing signal. A re-timing circuit is arranged to re-time a set of transitions of the frequency-divided signal to be temporally aligned to transitions of the 90° phase-shifted form of the reference timing signal to generate the timing signal comprising the re-timed transitions of the frequency-divided signal.

Advantageously, and as described in greater detail below, by utilising the re-timing circuit to re-time transitions of the odd-numbered frequency-divided signal to be temporally aligned to transitions of the 90° phase-shifted form of the reference timing signal in this manner, 90° phase-shifted odd-numbered frequency-divided signals may be generated. As a result, odd-numbered frequency division may be utilised for generating local oscillator signals within radio frequency transceivers, reducing the required frequency range of the synthesizer circuits necessary for achieving the increasing number of frequency bands in cellular telecommunications standards.

Referring now to FIG. 2, there is illustrated a simplified block diagram of a radio unit 200 with a radio frequency (RF) transceiver 202. The RF transceiver 202 comprises receive and transmit chains. The part of the receive chain illustrated in FIG. 2 includes a bandpass filter 210 arranged to receive an RF signal from an antenna (not shown), a low-noise amplifier 212, a mixer 214, a further bandpass filter 216 and an analogue to digital converter 218. The part of the transmit chain illustrated in FIG. 2 includes a digital to analogue converter 220, a bandpass filter 222, a mixer 224 and a power amplifier 226 arranged to output an RF signal for transmission to an antenna (not shown). The RF transceiver 202 further comprises a local oscillator synthesizer 230 arranged to receive a reference timing signal 235 and to generate therefrom local oscillator (LO) signals 232, 234 used by the mixers 214, 224 to down/up convert the respective receive/transmit signals.

As will be appreciated by a person skilled in the art, the signals within such an RF transceiver 202 typically comprise quadrature signals consisting of two signal components phase-shifted by 90° with respect to one another. Accordingly, each LO signal 232, 234 comprises a quadrature signal consisting of a first, in-phase (I) component and a second, quadrature (Q) component phase-shifted by 90° with respect to the in-phase component.

As previously stated, due to the increased number of frequency bands in cellular telecommunications standards, it is becoming increasingly desirable to be able to perform odd-numbered division in order to reduce the required frequency range of the synthesizer circuits used to generate local oscillator signals. However, unlike for even-numbered frequency division, a 90° phase-shift is not directly achievable with odd-numbered frequency division.

Referring now to FIG. 3, there is illustrated a timing diagram showing various timing signals, including a reference timing signal 235 and an inverted reference timing signal 320. The timing diagram of FIG. 3 further includes a ⅓ (i.e. odd-numbered) frequency-divided signal 330 generated from the reference timing signal 235. A 90° phase-shifted version of the ⅓ frequency-divided signal 330 is illustrated at 340. As illustrated in FIG. 3, for odd-numbered frequency-divided signals such as the ⅓ frequency-divided signals 330, 340, phase-shifting the frequency-divided signal by 90° results in the transitions within the phase-shifted signal 340 falling halfway between the transitions of the reference timing signal 235 and inverted reference timing signal 320, as illustrated by the broken lines 345. Accordingly, neither the reference timing signal 235 nor the inverted reference timing signal 320 can be used directly as a timing reference for generating the 90° phase-shifted ⅓ frequency-divided signal 340.

However, the inventors have recognised that a reference timing signal phase shifted by 90°, such as the reference timing signal 350 illustrated in FIG. 3, would provide transitions that coincide with the transitions of the 90° phase-shifted ⅓ frequency-divided signal 340, and thus that may be used to re-time the transitions of a ⅓ frequency-divided signal to generate the 90° phase-shifted ⅓ frequency-divided signals 330, 340.

Accordingly, the inventors propose utilising a 90° phase-shift component arranged to receive a reference timing signal, such as the reference timing signal 235 illustrated in FIGS. 2 and 3, and to generate the 90° phase-shifted form of the reference timing signal, such as the 90° phase-shifted reference timing signal 350 illustrated in FIG. 3. It is further proposed to utilise a re-timing circuit to re-time transitions of an odd-numbered frequency-divided signal having a frequency equal to 1/M times the frequency of the reference timing signal (where M is an odd-numbered integer) to be temporally aligned to transitions of the 90° phase-shifted form of the reference timing signal to generate the timing signal comprising the re-timed transitions of the frequency-divided signal. In this manner, 90° phase-shifted odd-numbered frequency-divided signals may be achieved.

In particular, for some example embodiments of the present invention, such as described in greater detail below, there is proposed a synthesizer arranged to generate a first timing signal and a further timing signal, the further timing signal comprising transitions that are 90° phase-shifted with respect to corresponding transitions within the first timing signal. The synthesizer circuit comprises an odd-numbered frequency divider circuit arranged to output a first frequency-divided signal having a frequency equal to 1/M times the frequency of a reference timing signal, and the synthesizer is arranged to generate the first timing signal based at least partly on transitions within the first frequency-divided signal. The odd-numbered frequency divider circuit is further arranged to output a second frequency-divided signal having a frequency equal to 1/M times the frequency of the reference timing signal and phase-shifted, for example by an amount Φ, with respect to the first frequency-divided signal. A re-timing circuit may then be utilised to re-time a set of transitions (e.g. comprising leading and/or trailing transitions) of the second frequency-divided signal to be temporally aligned to transitions of the 90° phase-shifted form of the reference timing signal to generate the further timing signal. For example, the re-timing circuit may be arranged to re-time the set of transitions of the second frequency-divided signal to be temporally aligned to transitions of the 90° phase-shifted form of the reference timing signal such that the set of transitions of the further timing signal are phase shifted by an amount Δ with respect to the set transitions of the second frequency-shifted signal, where Δ=90°−Φ such that the set of transitions of the further timing signal are phase shifted by 90° with respect to the set of transitions of the first timing signal.

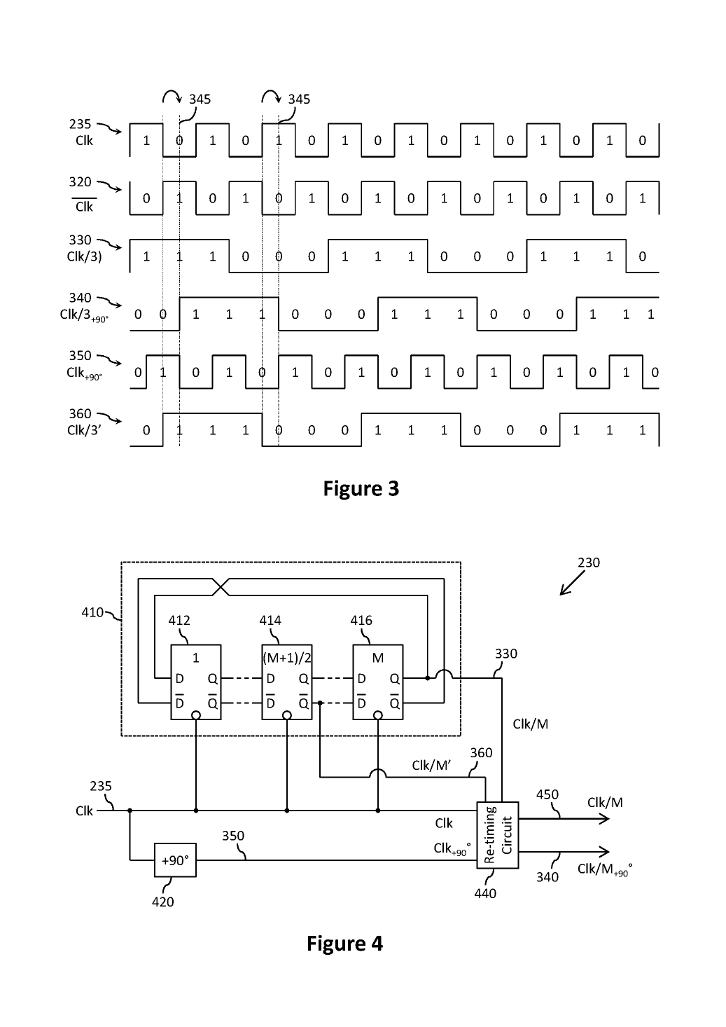

FIG. 4 schematically illustrates a simplified example of a part of such a synthesizer that may be used to implement the synthesizer 230 of FIG. 2 adapted in accordance with example embodiments of the present invention. The synthesizer 230 comprises an odd-numbered frequency divider circuit 410 arranged to receive a reference timing signal, such as the reference timing signal 235 illustrated in FIG. 3, and to output one or more frequency-divided signals 330, 360 having a frequency equal to 1/M times the frequency of the reference timing signal 235, where M is an odd-numbered integer.

In the example illustrated in FIG. 4, the odd-numbered frequency divider circuit 410 comprises M flip-flops 412, 414, 416 coupled in a loop whereby the outputs of each flip-flop 412, 414, 416 are coupled to respective inputs of the next flip-flop in the loop, with the exception of the M^{th} flip-flop 416 whose outputs are inversely coupled to the inputs of the first flip-flop 412 such that the non-inverted output of the M^{th} flip-flop 416 is coupled to the inverted input of the first flip-flop 412 whilst the inverted output of the M^{th} flip-flop 416 is coupled to the non-inverted input of the first flip-flop 412. The reference timing signal 235 is provided to the clock inputs of each of the flip-flops 412, 414, 416. In this manner, a state transition resulting from the inverse coupling of the M^{th} flip-flop 416 to the first flip-flop 412 is shifted along the flip-frequency divider circuit 410 by one flip-flop each clock cycle. As a result, each flip-flop output generates an oscillating signal having a frequency equal to 1/M times the frequency of the reference timing signal 235, with the respective signal being phase-shifted relative to the signal of the preceding flip-flop by 180°/M.

The synthesizer 230 of FIG. 4 further comprises a 90° phase-shift component 420 arranged to receive the reference timing signal 235 and to output a 90° phase-shifted form of the reference timing signal 350.

The synthesizer 230 further comprises a re-timing circuit 440 arranged to receive the frequency-divided signal 330, 360 output by the odd-numbered frequency divider circuit 410 and the 90° phase-shifted form of the reference timing signal 350, and to re-time transitions of at least one of the frequency-divided signals 330, 360 to the 90° phase-shifted form of the reference timing signal 350 to generate one or more timing signals having a frequency equal to 1/M times the frequency of the reference timing signal and comprising the re-timed transitions of the at least one frequency-divided signal 330, 360, such as described in greater detail below. In the example illustrated in FIG. 4, the synthesizer 230 is arranged to generate a first timing signal 450 and a further timing signal 340, at least one of which comprising the re-timed transitions of the at least one frequency-divided signal 330, 360.

In the illustrated example of FIG. 4, the odd-numbered frequency divider circuit 410 is arranged to output a first frequency-divided signal 330 having a frequency equal to 1/M times the frequency of the reference timing signal. The re-timing circuit 440 is arranged to receive the first frequency-divided signal 330 and to generate the first timing signal 450 comprising transitions corresponding to transitions within the first frequency-divided signal 330.

The odd-numbered frequency divider circuit 410 is further arranged to output a second frequency-divided signal 360 having a frequency equal to 1/M times the frequency of the reference timing signal and phase-shifted by Φ with respect to the first frequency-divided signal 330.

In the illustrated example, the first frequency-divided signal 330 is output by the non-inverted output of the M^{th} flip-flop 416 of the odd-numbered frequency divider circuit 410 and the second frequency-divided signal 360 is output by the inverted output of the ((M+1)/2)^{th} flip-flop 414 of the odd-numbered frequency divider circuit 410. Accordingly, the second frequency-divided signal 360 is phase-shifted by Φ=((M+1)/2)*(360°/M)−180° with respect to the first frequency-divided signal 330. Thus, in the case where the odd-numbered frequency divider circuit 410 comprises a ⅓ frequency divider circuit (i.e. where M=3), the M^{th} flip-flop 416 comprises the 3^{rd} flip-flop 416 in the frequency divider circuit 410 and the ((M+1)/2)^{th} flip-flop 414 comprises the 2^{nd} flip-flop 414 in the frequency divider circuit 410. Accordingly, the first and second frequency-divided signals 330, 360 are phase-shifted relative to one another by Φ=(2*360°/3)−180°=60°, as illustrated in FIG. 3.

In the example illustrated in FIG. 4, the re-timing circuit 440 is arranged to receive the second frequency-divided signal 360 and to generate the further timing signal 340 by re-timing a set of transitions (e.g. comprising leading and/or trailing transitions) of the second frequency-divided signal 360 to be temporally aligned to transitions of the 90° phase-shifted form of the reference timing signal 350 such that the corresponding set of transitions of the further timing signal 340 are phase shifted by Δ with respect to the respective transitions of the second frequency-shifted signal 360, where Δ=90°−Φ. In this manner, the transitions of the further timing signal 340 synchronised to the 90° phase-shifted form of the reference timing signal 350 are phase shifted by 90° with respect to the corresponding transitions of the first timing signal 450.

In particular, the re-timing circuit 440 illustrated in FIG. 4 is arranged to re-time the transitions of the second frequency-divided signal 360 to be temporally aligned to transitions of the 90° phase-shifted form of the reference timing signal 350 such that the transitions of the second frequency-divided signal 360 are delayed by a quarter of a cycle of the reference timing signal 235, thereby introducing a phase shift Δ equal to 90°/M (i.e. 30° in the case where M=3) to the transitions of the second frequency-divided signal 360. Notably, as described above, the second frequency-divided signal 360 is phase-shifted by D (i.e. 60° in the case where M=3) with respect to the first frequency-divided signal 330. Accordingly, re-timing the transitions of the second frequency-divided signal 360 to be temporally aligned to transitions of the 90° phase-shifted form of the reference timing signal 350 results in the generated timing signal 340 being phase-shifted with respect to the first frequency-divided signal 330 (and thus the first timing signal 450) by Φ+Δ=90°.

Frequency-divided signals generated by frequency divider circuits are prone to high levels of phase noise. Advantageously, the re-timing of the transitions of the second frequency-divided signal 360 to be temporally aligned to transitions of the 90° phase-shifted form of the reference timing signal 350 by the re-timing circuit 440 provides the additional benefit of generating the further phase-shifted frequency-divided signal 340 whilst at the same time substantially removing phase noise from the odd-numbered frequency divider circuit 410.

In the example illustrated in FIG. 4, the re-timing circuit 440 is further arranged to receive the reference timing signal 235 and to re-time the transitions of the first frequency-divided signal 330 to be temporally aligned to transitions of the (non-phase-shifted) reference timing signal 235 to generate a ‘clean’ frequency-divided signal 450, i.e. phase noise from the odd-numbered frequency-divided circuit 410 substantially removed, and having a frequency and phase substantially matching the first frequency-divided signal 330 output by the odd-numbered frequency divider circuit 410.

In accordance with some example embodiments, the re-timing circuit 440 of FIG. 4 is arranged to re-time leading and trailing transitions of the second frequency-divided signal 360 to be temporally aligned to transitions of the 90° phase-shifted form of the reference timing signal 350 to generate the further timing signal 340 such that the leading transitions and the trailing transitions of the further timing signal 340 are phase shifted by 90° with respect to leading transitions and trailing transitions of the first timing signal 450. In this manner, the synthesizer 230 may be arranged to generate the first timing signal 450 and the further timing signal 340 comprising 50% duty cycles, and 90° phase-shifted with respect to one another.

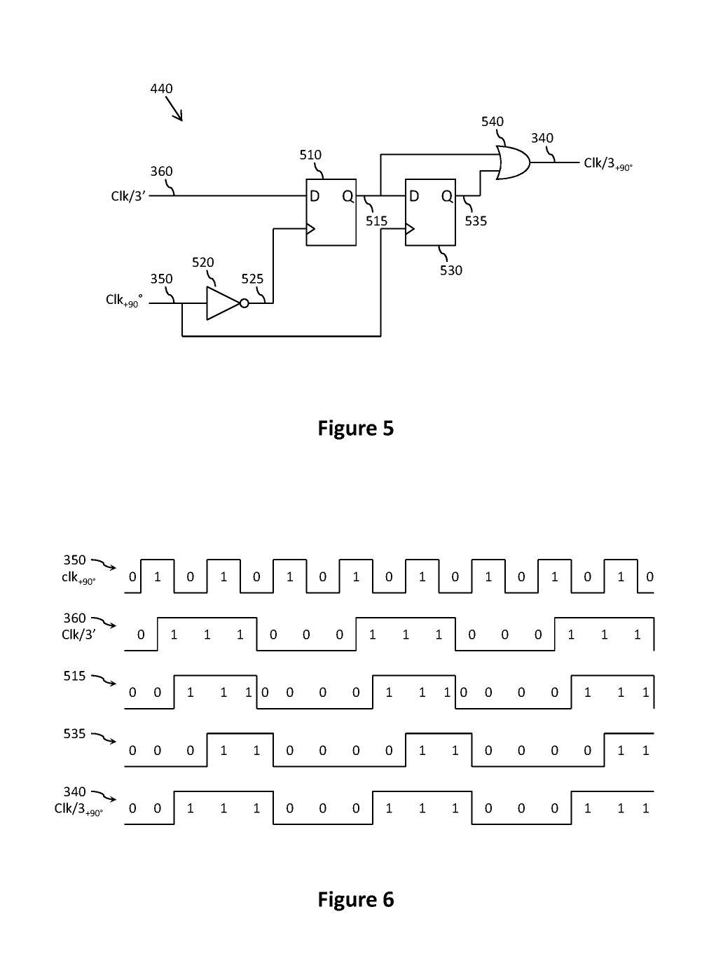

FIG. 5 illustrates a simplified circuit diagram of an example of a part of the re-timing circuit 440 arranged to generate the further phase-shifted frequency-divided signal 340.

The re-timing circuit 440 comprises a first latch component 510 arranged to receive at a data input thereof the second frequency-divided signal 360. The first latch component 510 is further arranged to receive at a clock input thereof an inverted form 525 of the 90° phase-shifted form of the reference timing signal 350, produced by an inverter 520. In the manner, the first latch component 510 is arranged to sample and output the second frequency-divided signal 360 synchronously with the inverted form of the 90° phase-shifted form of the reference timing signal 525.

The output signal 515 of the first latch component 510 is provided to a data input of a second latch component 530. The second latch component 530 is further arranged to receive at a clock input thereof the 90° phase-shifted form of the reference timing signal 350. In the manner, the second latch component 530 is arranged to sample and output the output signal 515 of the first latch component 510 synchronously with the (non-inverted) 90° phase-shifted form of the reference timing signal 350.

An OR gate 540 is arranged to receive at inputs thereof the output signals 515, 535 of the first and second latch components 510, 530. The OR gate 540 outputs the further phase-shifted frequency-divided signal 340. FIG. 6 illustrates a timing diagram illustrating the timing of signals within the example re-timing circuit 440 illustrated in FIG. 5.

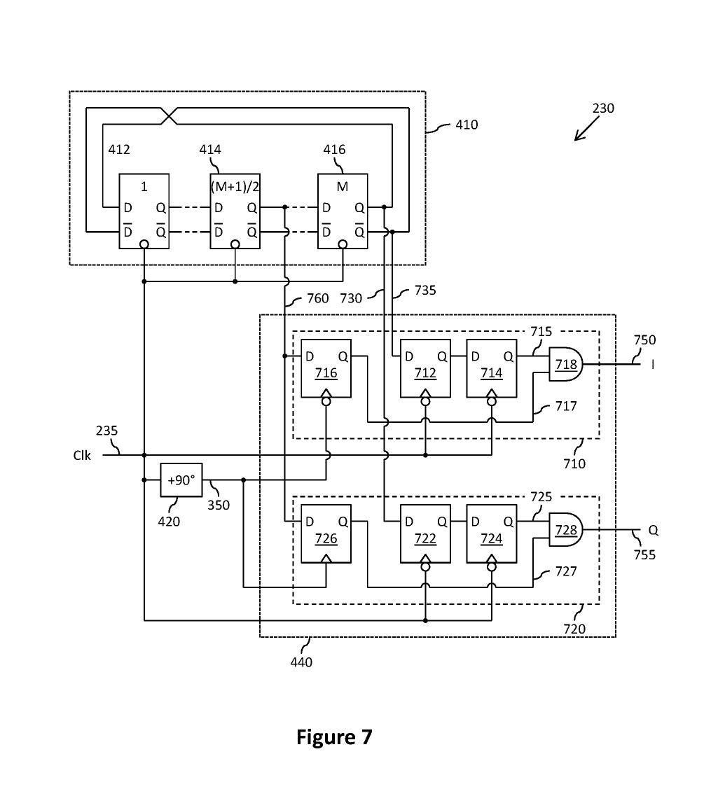

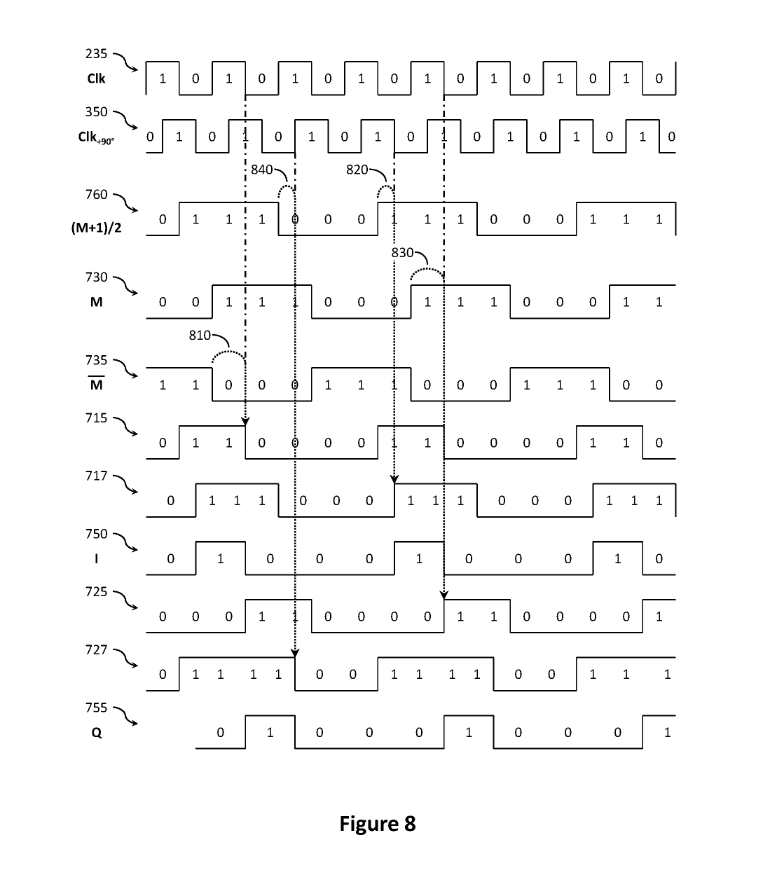

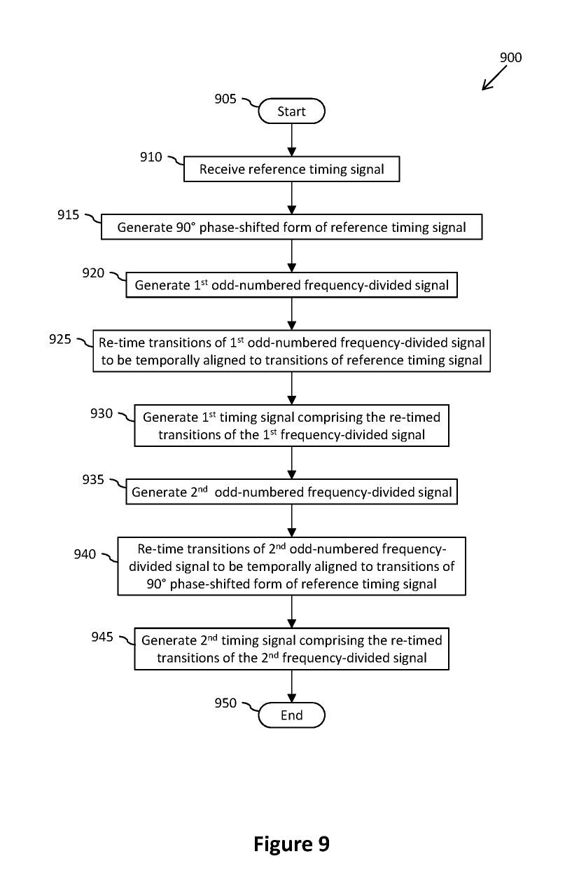

FIG. 7 schematically illustrates an alternative example of a part of a synthesizer that may be used to implement the synthesizer 230 of FIG. 2. The synthesizer 230 comprises an odd-numbered frequency divider circuit 410 arranged to receive a reference timing signal 235, and to output one or more frequency-divided signals 730, 735, 760 having a frequency equal to 1/M times the frequency of the reference timing signal 235, where M is an odd-numbered integer. FIG. 8 illustrates a timing diagram for various signals within the synthesizer circuit of FIG. 7.

In the example illustrated in FIG. 7, the odd-numbered frequency divider circuit 410 comprises M flip-flops 412, 414, 416 coupled in a loop whereby the outputs of each flip-flop 412, 414, 416 are coupled to respective inputs of the next flip-flop in the loop, with the exception of the M^{th} flip-flop 416 whose outputs are inversely coupled to the inputs of the first flip-flop 412 such that the non-inverted output of the M^{th} flip-flop 416 is coupled to the inverted input of the first flip-flop 412 whilst the inverted output of the M^{th} flip-flop 416 is coupled to the non-inverted input of the first flip-flop 412. The reference timing signal 235 is provided to the clock inputs of each of the flip-flops 412, 414, 416. In this manner, a state transition resulting from the inverse coupling of the M^{th} flip-flop 416 to the first flip-flop 412 is shifted along the flip-frequency divider circuit 410 by one flip-flop each clock cycle. As a result, each flip-flop output generates an oscillating signal having a frequency equal to 1/M times the frequency of the reference timing signal 235, with the respective signal being phase-shifted relative to the signal of the preceding flip-flop by 180°/M.

The synthesizer 230 of FIG. 7 further comprises a 90° phase-shift component 420 arranged to receive the reference timing signal 235 and to output a 90° phase-shifted form of the reference timing signal 350.

The synthesizer 230 further comprises a re-timing circuit 440 arranged to receive the frequency-divided signals 730, 735, 760 output by the odd-numbered frequency divider circuit 410 and the 90° phase-shifted form of the reference timing signal 350, and to re-time transitions of the frequency-divided signals 730, 735, 760 to the 90° phase-shifted form of the reference timing signal 350 to generate one or more timing signals having a frequency equal to 1/M times the frequency of the reference timing signal and comprising the re-timed transitions of the frequency-divided signals 730, 735, 760. In the example illustrated in FIG. 7, the synthesizer 230 is arranged to generate a first timing signal 750 and a second timing signal 755, at least one of which comprising the re-timed transitions of the at least one frequency-divided signal 730, 735, 760. Specifically, for the example illustrated in FIG. 7, the synthesizer 230 is arranged to generate quadrature (I/Q) timing signals 750, 755. Accordingly, and as described in greater detail below, the synthesizer 230 is arranged to generate the first and second timing signals 750, 755 to be 90° phase-shifted with respect to one another and comprising a 25% duty cycle.

In the illustrated example of FIG. 7, the odd-numbered frequency divider circuit 410 is arranged to output a pair of complementary frequency-divided signals 730, 735 having a frequency equal to 1/M times the frequency of the reference timing signal. The complementary frequency-divided signals 730, 735 may be considered to comprise a non-inverted frequency-divided signal 730 and an inverted frequency-divided signal 735 180° phase-shifted relative to one another. The odd-numbered frequency divider circuit 410 is further arranged to output a further frequency-divided signal 760 having a frequency equal to 1/M times the frequency of the reference timing signal and phase-shifted by Φ with respect to the non-inverted signal 730 of the pair of complementary frequency-divided signals.

In the illustrated example, the pair of complementary frequency-divided signals 730, 735 are output by the non-inverted and inverted outputs respectively of the M^{th} flip-flop 416 of the odd-numbered frequency divider circuit 410 and the further frequency-divided signal 760 is output by the non-inverted output of the ((M+1)/2)^{th} flip-flop 414 of the odd-numbered frequency divider circuit 410. Accordingly, the non-inverted signal 730 of the pair of complementary frequency-divided signals is phase-shifted by Φ=((M−1)/2)*(180°/M) with respect to the further frequency-divided signal 760. Thus, in the case where the odd-numbered frequency divider circuit 410 comprises a ⅓ frequency divider circuit (i.e. where M=3), the M^{th} flip-flop 416 comprises the 3^{rd} flip-flop in the frequency divider circuit 410 and the ((M+1)/2)^{th} flip-flop 414 comprises the 2^{nd} flip-flop in the frequency divider circuit 410. Accordingly, the non-inverted signal 730 of the pair of complementary frequency-divided signals is phase-shifted by Φ=((2/2)*(180°/3))=60° with respect to the further frequency-divided signal 760.

In the example illustrated in FIG. 7, the re-timing circuit 440 comprises a first re-timing component 710 arranged to generate the first (I) timing signal 750 and a second re-timing component 720 arranged to generate the second (Q) timing signal 755.

In the illustrated example, the first re-timing component 710 of the re-timing circuit 440 is arranged to receive the inverted signal 735 of the pair of complementary frequency-divided signals and the reference timing signal 235, and to re-time the transitions of the received frequency-divided signal 735 to be temporally aligned to transitions of the reference timing signal 235 to generate a first re-timed signal 715. The first re-timing component 710 of the re-timing circuit 440 is further arranged to receive the further frequency-divided signal 760 and the 90° phase-shifted reference timing signal 350, and to re-time the transitions of the further frequency-divided signal 760 to be temporally aligned to transitions of the 90° phase-shifted reference timing signal 350 to generate a second re-timed signal 717. The first (I) timing signal 750 is then generated from the first and second re-timed signals 715, 717.

In particular for the illustrated example of FIG. 7, the first re-timing component 710 comprises a first latch 712 arranged to receive at a data input thereof the inverted signal 735 of the pair of complementary frequency-divided signals. The first re-timing component 710 further comprises a second latch 714 arranged to receive at a data input thereof the output signal from the first latch 712. The first and second latches 712, 714 are further arranged to receive the reference timing signal 235 at inverting clock inputs thereof. In this manner, the first and second latches 712, 714 form a flip-flop structure arranged to sample and hold the inverted signal 735 of the pair of complementary frequency-divided signals on trailing (falling) edges of the reference timing signal 235, with the output of the flip-flop structure (i.e. the output of the second latch 714) providing the first re-timed signal 715. Accordingly, the flip-flop structure formed by the first and second latches 712, 714 is arranged to re-time the transitions of the inverted signal 735 of the pair of complementary frequency-divided signals to be temporally aligned to trailing (falling) edges of the reference timing signal 235, such as indicated at 810 in FIG. 8, to generate the first re-timed signal 715.

The first re-timing component 710 further comprises a third latch 716 arranged to receive at a data input thereof the further frequency-divided signal 760, and the 90° phase-shifted reference timing signal 350 at an inverting clock input thereof. In this manner, the third latch 716 is arranged to sample and output (as the second re-timed signal 717) the further frequency-divided signal 760 during ‘low’ phases of the 90° phase-shifted reference timing signal 350. Accordingly, the third latch 716 is arranged to re-time leading (rising) transitions of the further frequency-divided signal 760 to be temporally aligned to trailing (falling) edges of the 90° phase-shifted reference timing signal 350, such as indicated at 820 in FIG. 8.

In the example illustrated in FIG. 7 the first re-timing component 710 further comprises an AND gate 718 arranged to receive at inputs thereof the first and second re-timed signals 715, 717, and to output the first (I) timing signal 750 based on the received first and second re-timed signals 715, 717. Accordingly, and as illustrated in FIG. 8, the resulting first (I) timing signal 750 comprises a frequency equal to ⅓ the frequency of the reference timing signal 235, with a 25% duty cycle.

In the illustrated example, the second re-timing component 720 of the re-timing circuit 440 is arranged to receive the non-inverted signal 730 of the pair of complementary frequency-divided signals and the reference timing signal 235, and to re-time the transitions of the received frequency-divided signal 730 to be temporally aligned to transitions of the reference timing signal 235 to generate a third re-timed signal 725. The second re-timing component 720 of the re-timing circuit 440 is further arranged to receive the further frequency-divided signal 760 and the 90° phase-shifted reference timing signal 350, and to re-time the transitions of the further frequency-divided signal 760 to be temporally aligned to transitions of the 90° phase-shifted reference timing signal 350 to generate a fourth re-timed signal 727. The second (Q) timing signal 755 is then generated from the third and fourth re-timed signals 725, 727.

In particular for the illustrated example of FIG. 7, the second re-timing component 720 comprises a first latch 722 arranged to receive at a data input thereof the non-inverted signal 730 of the pair of complementary frequency-divided signals. The second re-timing component 720 further comprises a second latch 724 arranged to receive at a data input thereof the output signal from the first latch 722. The first and second latches 722, 724 are further arranged to receive the reference timing signal 235 at inverting clock inputs thereof. In this manner, the first and second latches 722, 724 form a flip-flop structure arranged to sample and hold the non-inverted signal 730 of the pair of complementary frequency-divided signals on trailing (falling) edges of the reference timing signal 235, with the output of the flip-flop structure (i.e. the output of the second latch 724) providing the third re-timed signal 725. Accordingly, the flip-flop structure formed by the first and second latches 722, 724 is arranged to re-time the transitions of the non-inverted signal 730 of the pair of complementary frequency-divided signals to be temporally aligned to trailing (falling) edges of the reference timing signal 235, such as indicated at 830 in FIG. 8, to generate the third re-timed signal 725.

The second re-timing component 720 further comprises a third latch 726 arranged to receive at a data input thereof the further frequency-divided signal 760, and the 90° phase-shifted reference timing signal 350 at a non-inverting clock input thereof. In this manner, the third latch 726 is arranged to sample and output (as the second re-timed signal 727) the further frequency-divided signal 760 during ‘high’ phases of the 90° phase-shifted reference timing signal 350. Accordingly, the third latch 726 is arranged to re-time trailing (falling) transitions of the further frequency-divided signal 760 to be temporally aligned to leading (rising) edges of the 90° phase-shifted reference timing signal 350, such as indicated at 840 in FIG. 8.

In the example illustrated in FIG. 7 the second re-timing component 720 further comprises an AND gate 728 arranged to receive at inputs thereof the third and fourth re-timed signals 725, 727, and to output the second (Q) timing signal 755 based on the received third and fourth re-timed signals 725, 727. Accordingly, and as illustrated in FIG. 8, the resulting second (Q) timing signal 755 comprises a frequency equal to ⅓ the frequency of the reference timing signal 235, with a 25% duty cycle.

Notably, the leading transitions of the first (I) timing signal 750 are temporally aligned to the leading transitions of the second re-timed signal 717, and thus to leading transitions of the further frequency-divided signal 760 re-timed to be temporally aligned to trailing (falling) edges of the 90° phase-shifted reference timing signal 350. Accordingly, and as illustrated in FIG. 8, the leading transitions of the first (I) timing signal 750 are phase-shifted by A=90°/M (i.e. 30° in the case where M=3) with respect to the leading transitions of the further frequency-divided signal 760. Conversely, the leading transitions of the second (Q) timing signal 755 are temporally aligned to the leading transitions of the third re-timed signal 725, and thus to leading transitions of the non-inverted signal 730 of the pair of complementary frequency-divided signals re-timed to be temporally aligned to trailing (falling) edges of the reference timing signal 235. Accordingly, and as illustrated in FIG. 8, the leading transitions of the second (Q) timing signal 750 are phase-shifted by Δ=180°/M (i.e. 60° in the case where M=3) with respect to the leading transitions of the non-inverted signal 730 of the pair of complementary frequency-divided signals.

As outlined above, the non-inverted signal 730 of the pair of complementary frequency-divided signals is phase-shifted by Φ=60° with respect to the further frequency-divided signal 760. Accordingly, the leading transitions of the second (Q) timing signal 755 are phase-shifted 60°+30°=90° with respect to the first (I) timing signal 750.

Referring now to FIG. 9, there is illustrated a simplified flowchart 900 of a method of generating a timing signal from a reference timing signal, such as may be implemented within the synthesizer 230 illustrated in FIG. 4. The method of FIG. 9 starts at 905, and moves on to 910 where a reference timing signal is received, such as the reference timing signal 235 in FIG. 4. A 90° phase-shifted form of the reference timing signal is generated at 915, such as the 90° phase-shifted reference timing signal 350 in FIG. 4.

A first odd-numbered frequency-divided signal is generated at 920 having a frequency equal to 1/M times the frequency of the reference timing signal, where M is an odd-numbered integer, such as the frequency-divided signal 330 in FIG. 4. A set of transitions of the first frequency-divided signal are re-timed at 925 to be temporally aligned to transitions of the reference timing signal. The set of transitions may include leading and/or trailing transitions of the first frequency-divided signal. A first timing signal is then generated at 930 comprising the re-timed transitions of the first frequency-divided signal, such as the timing signal 450 in FIG. 4.

A second odd-numbered frequency-divided signal is generated at 935, also having a frequency equal to 1/M times the frequency of the reference timing signal, such as the second frequency-divided signal 360 in FIG. 4. A set of transitions of the second frequency-divided signal are re-timed at 940 to be temporally aligned to transitions of the 90° phase-shifted form of the reference timing signal. The set of transitions may include leading and/or trailing transitions of the second frequency-divided signal. A second timing signal is then generated at 945 comprising the re-timed transitions of the second frequency-divided signal, such as the timing signal 340 in FIG. 4.

The method of FIG. 9 then ends at 950.

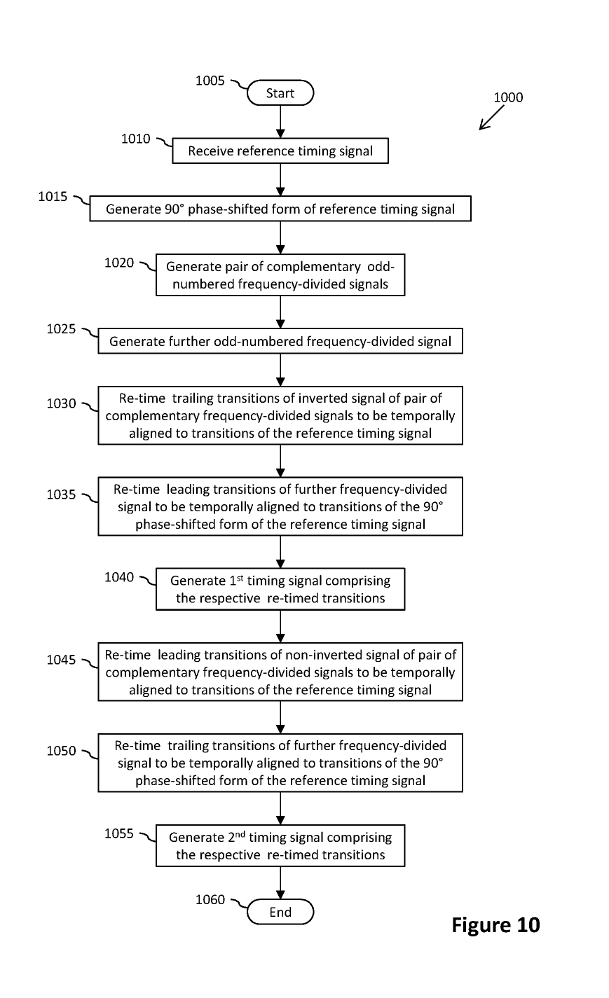

Referring now to FIG. 10, there is illustrated a simplified flowchart 1000 of a method of generating a timing signal from a reference timing signal, such as may be implemented within the synthesizer 230 illustrated in FIG. 7. The method of FIG. 10 starts at 1005, and moves on to 1010 where a reference timing signal is received, such as the reference timing signal 235 in FIG. 7. A 90° phase-shifted form of the reference timing signal is generated at 1015, such as the 90° phase-shifted reference timing signal 350 in FIG. 7.

A pair of complementary odd-numbered frequency-divided signals is generated at 1020 having a frequency equal to 1/M times the frequency of the reference timing signal, where M is an odd-numbered integer, such as the pair of complementary frequency-divided signals 730, 735 in FIG. 7. A further odd-numbered frequency-divided signal is generated at 1025, also having a frequency equal to 1/M times the frequency of the reference timing signal, such as the further frequency-divided signal 760 in FIG. 7.

A first set of transitions of an inverted signal of the pair of complementary frequency-divided signals are re-retimed at 1030 to be temporally aligned to transitions of the reference timing signal. In the illustrated example, the first set of transitions in step 1030 comprises trailing transitions of the inverted signal of the pair of complementary frequency-divided signals.

A second set of transitions of the further frequency-divided signal are re-timed at 1035 to be temporally aligned to transitions of the 90° phase-shifted form of the reference timing signal. In the illustrated example, the second set of transitions in step 1035 comprises leading transitions of the further frequency-divided signal.

A first timing signal is then generated at 1040 comprising the re-timed first and second sets of transitions of the frequency-divided signals, such as the timing signal 750 in FIG. 7.

A third set of transitions of a non-inverted signal of the pair of complementary frequency-divided signals are re-retimed at 1045 to be temporally aligned to transitions of the reference timing signal. In the illustrated example, the third set of transitions in step 1045 comprises leading transitions of the non-inverted signal of the pair of complementary frequency-divided signals.

A fourth set of transitions of the further frequency-divided signal are re-timed at 1050 to be temporally aligned to transitions of the 90° phase-shifted form of the reference timing signal. In the illustrated example, the fourth set of transitions in step 1050 comprises trailing transitions of the further frequency-divided signal.

A second timing signal is then generated at 1055 comprising the re-timed third and fourth sets of transitions of the frequency-divided signals, such as the timing signal 755 in FIG. 7.

The method of FIG. 10 then ends, at 1060.

In the example illustrated in FIG. 10 and described above, sets of transitions comprising leading transitions of the respective frequency-divided signals are re-timed at steps 1035 and 1045, and sets of transitions comprising trailing transitions of the respective frequency-divided signals are re-timed at steps 1030 and 1050. However, it will be appreciated that the sets of transitions may alternatively comprise opposing transition types. For example, it is contemplated that sets of transitions comprising trailing transitions of the respective frequency-divided signals may alternatively be re-timed at steps 1035 and 1045, and sets of transitions comprising leading transitions of the respective frequency-divided signals may alternatively be re-timed at steps 1030 and 1050.

In some examples, some or all of the steps illustrated in the flowchart may be implemented in hardware and/or some or all of the steps illustrated in the flowchart may be implemented in software.

Thus, the hereinbefore examples provide a timing signal generation apparatus for use in a synthesizer. In particular, the hereinbefore examples of apparatus and methods are capable of generating timing signals from odd-numbered frequency divider circuits comprising 90° phase-shifted transitions.

In many applications the accuracy of the timing of the rising and falling transitions of high frequency signals output by frequency divider circuits is important, within any errors introducing phase noise within the signals. Accordingly, there is a need for ensuring the accuracy of the rising and falling transitions of the frequency divider circuit output signals. In the various example embodiments hereinbefore described, a re-timing circuit is used to re-time transitions of the frequency-divided signal to be temporally aligned to transitions of a 90° phase-shifted form of the reference timing signal, and also in some examples to transitions of the reference timing signal itself. Accordingly, the accuracy of the 90° phase-shift component 420 arranged to generate the 90° phase-shifted form of the reference timing signal 350 is a key factor in the accuracy of the timing of the rising and falling transitions of the timing signals 340, 450, 750, 755 output by the respective synthesizers 230.

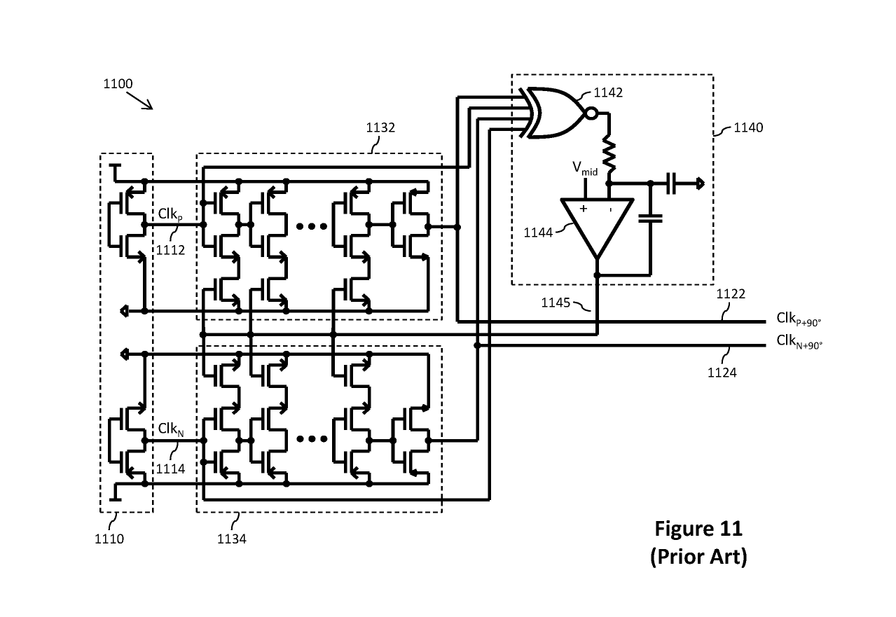

FIG. 11 illustrates a simplified circuit diagram of an example of a delay-locked loop circuit 1100 for generating a 90° phase-shifted form of a received timing signal. Specifically, the delay-locked loop circuit 1100 illustrated in FIG. 11 is arranged to receive a differential reference timing signal from a reference timing signal source, illustrated generally at 1110, the differential reference timing signal comprising a pair of differential signal components Clk_{P} 1112 and Clk_{N} 1114. Each of the differential signal components Clk_{P} 1112 and Clk_{N} 1114 is provided to a respective delay circuit 1132, 1134. Each delay circuit 1132, 1134 is arranged to apply a delay to transitions (rising and falling transitions) within the received differential signal component Clk_{P} 1112, Clk_{N} 1114 and to output a respective 90° phase-shifted differential signal component Clk_{P+90°} 1122, Clk_{N+90°} 1124 comprising the delayed transitions. The 90° phase-shifted differential signal components Clk_{P+90°} 1122, Clk_{N+90°} 1124 are then output by the delay-locked loop circuit 1100 as the 90° phase-shifted form of the received differential reference timing signal.

A delay control component 1140 is arranged to receive the differential signal components Clk_{P} 1112, Clk_{N} 1114 and the 90° phase-shifted differential signal components Clk_{P+90°} 1122, Clk_{N+90°} 1124, and to output a delay control signal 1145. The delay control signal 1145 is fed back to the delay circuits 1132, 1134 and is arranged to control the amount of delay applied by the delay circuits 1132, 1134 to the respective 90° phase-shifted differential signal components Clk_{P+90°} 1122, Clk_{N+90°} 1124.

The delay control component 1140 illustrated in FIG. 11 comprises an eXclusive NOR (XNOR) gate 1142, i.e. a circuit that outputs a logical ‘0’ when the number of logical ‘1s’ at its inputs is odd, and a logical ‘1’ when the number of logical ‘1s’ at its inputs is even. Accordingly, the XNOR gate 1142 is arranged to receive at inputs thereof the differential signal components Clk_{P} 1112, Clk_{N} 1114 and the 90° phase-shifted differential signal components Clk_{P+90°} 1122, Clk_{N+90°} 1124. An output of the XNOR gate 1142 is coupled to a first input of a comparator 1144 arranged to output the delay control signal 1145. When the delay applied by the delay circuits 1132, 1134 causes a 90° phase shift in the respective phase-shifted signal components 1122, 1124, the output of the XNOR gate 1142 will comprise a 50% duty cycle. An RC circuit coupled between the output of the XNOR gate 1142 and the first input of the comparator 1144 averages the output voltage of the XNOR gate 1142 at the first input of the comparator 1144. Thus, when the signal output by the XNOR gate 1142 comprises a 50% duty cycle, the voltage at the first input of the comparator 1144 will comprise a voltage V_{mid} substantially equal to half the supply voltage. Accordingly, by providing a corresponding voltage V_{mid} to a second input of the comparator 1144, the comparator 1144 is arranged to drive the delay control signal 1145 to achieve a 50% duty cycle in the output of the XNOR gate 1142, and thus a 90° phase shift in the respective phase-shifted signal components 1122, 1124.

A problem with the delay-locked loop circuit 1100 illustrated in FIG. 11 is that due to process, voltage and temperature (PVT) variations, the delays applied to the rising transitions can vary independently from the delays applied to the falling transitions in each of the 90° phase-shifted differential signal components Clk_{P-90°} 1122, Clk_{N+90°} 1124. Accordingly, because this approach to a delay-locked loop circuit averages out the errors in order to generate a single, communal delay control signal, any errors resulting from such PVT variations are averaged across the resulting phase-shifted signal components 1122, 1124, not corrected. As such, the accuracy of the rising and falling transitions of the 90° phase-shifted differential signal components Clk_{P+90°} 1122, Clk_{N+90°} 1124 output by the delay-locked loop circuit 1100 illustrated in FIG. 11 cannot be assured.

Because the errors in the rising and falling transitions of the resulting phase-shifted signal components 1122, 1124 are averaged rather than cancelled, asymmetries may be generated in the 90° phase-shifted reference timing signal output by the delayed-locked loop circuit 1100. Thus, if such an asymmetric 90° phase-shifted signal is used for re-timing transitions of the frequency-divided signals within the synthesizer 230, the result is the introduction of phase noise within the signals output by the synthesizer 230. In particular, in the example illustrated in FIG. 7 such an asymmetric 90° phase-shifted signal would result in IQ imbalance of the quadrature (I/Q) timing signals 750, 755.

In order to overcome the problem of ensuring the accuracy of the timing of transitions within re-timed signals, there is proposed a novel phase-shifter circuit architecture comprising a delay circuit arranged to receive a reference timing signal and to delay transitions within the reference timing signal to generate a phase-shifted form of the reference timing signal, wherein the amount of delay applied by the delay circuit to the transitions within the reference timing signal is controllable by a delay control signal generated by a delay control circuit. The delay control circuit is arranged to receive one or more re-timed signal(s) comprising transitions re-timed to transitions of the phase-shifted form of the reference timing signal output by the phase-shifter circuit, and to generate the delay control signal for the delay circuit based at least partly on the received re-timed signal(s).

Advantageously, by generating the delay control signal based on the re-timed signals in this manner, the delay applied by the delay circuit to the transitions within the reference timing signal can be controlled to compensate for transition timing errors within the re-timed signal(s), and thus to ensure the accuracy of the timing of the transitions within the re-timed signals themselves.

For example, intra-signal duty cycle errors within a received re-timed signal may be detected by way of, for example, deriving an averaged voltage indication for the received re-timed signal and comparing it to a reference voltage level to generate the delay control signal. Accordingly, the delay control circuit may be arranged to drive the delay control signal to achieve a desired duty cycle in the re-timed signals, for example by compensating for asymmetry between the rising and falling edges of the phase-shifted form of the reference timing signal caused by PVT variations etc.

Additionally/alternatively, in the case where there are multiple re-timed signals having transitions re-timed to transitions of both the reference timing signal and the phase-shifted form of the reference timing signal, a comparison of the received re-timed signals may be used to correct transition timing errors within the phase-shifted form of the reference timing with respect to the principal reference timing signal. For example, and as described in greater detail below, the delay control circuit may be arranged to receive:
a first re-timed signal comprising a first set of transitions (e.g. rising transitions) re-timed to rising transitions of the reference timing signal and the second set of transitions (e.g. falling) transitions re-timed to rising or falling transitions of the phase-shifted form of the reference timing signal; and
a second re-timed signal comprising a first set of transitions (e.g. rising transitions) re-timed to falling transitions of the reference timing signal and the second set of transitions (e.g. falling) transitions re-timed to the same rising or falling transitions of the phase-shifted form of the reference timing signal as the first re-timed signal.

In this manner, the first re-timed signal provides a reference of the timing of the rising transitions of the reference timing signal relative to one of the rising and falling transitions of the phase-shifted form of the reference timing signal, and the second re-timed signal provides a reference of the timing of the falling transitions of the reference timing signal relative to the same one of the rising and falling transitions of the phase-shifted form of the reference timing signal. Accordingly, a comparison of the first and second re-timed signals enables the accuracy of one of the rising or falling transitions of the phase-shifted form of the reference timing signal to be assessed in relation to the rising and falling transitions of the original reference timing signal and the delay control signal generated accordingly, for example to compensate for asymmetry between the rising and falling edges of the phase-shifted form of the reference timing signal caused by PVT variations etc.

Notably, by generating the delay control signal based on received re-timed signals in this manner, the errors introduced at any point prior to the re-timed signal(s) being generated may be corrected, for example including errors within the original reference timing signal, errors introduced by the phase-shifter circuit itself and/or errors introduced by a re-timing circuit arranged to generate the re-timed signal(s).

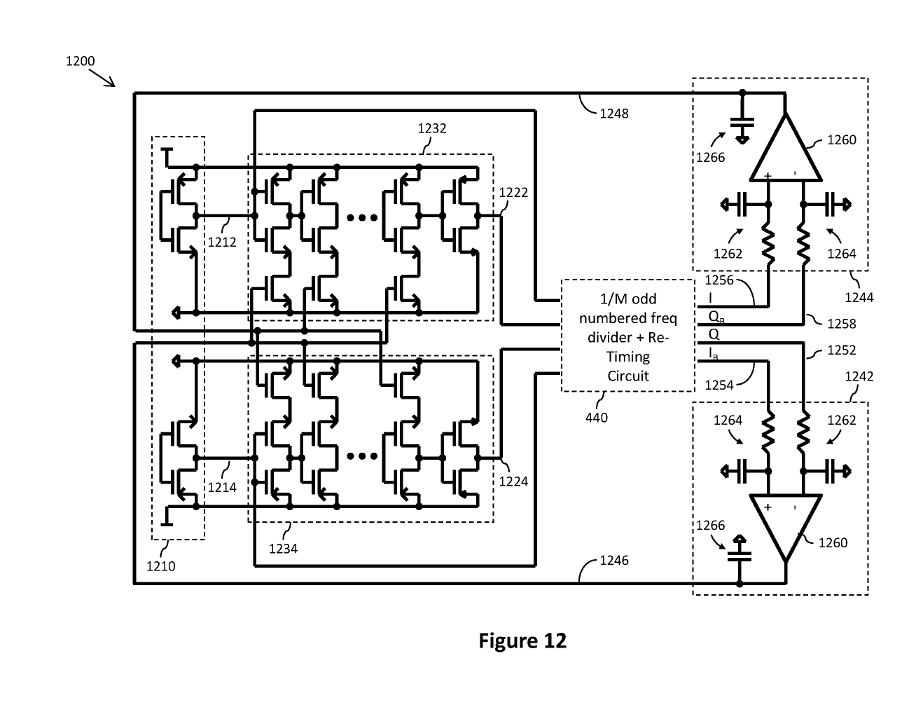

Referring now to FIG. 12, there is illustrated a simplified circuit diagram of an example of such a phase-shifter circuit 1200 for generating a phase-shifted form of a received timing signal, such as may be used to implement the 90° phase-shift component 420 of FIGS. 4 and/or 7 arranged to output the 90° phase-shifted form of the reference timing signal 350.

The example phase-shifter circuit 1200 illustrated in FIG. 12 is arranged to receive a differential reference timing signal from a reference timing signal source, illustrated generally at 1210, the differential reference timing signal comprising a pair of differential signal components 1212 and 1214. In FIGS. 4 and 7 such a reference timing signal is represented by the reference timing signal 235. Each of the differential signal components 1212 and 1214 is provided to a respective delay circuit 1232, 1234. Each delay circuit 1232, 1234 is arranged to apply a delay to transitions (rising and falling edges) within the received differential signal component 1212, 1214 and to output a respective phase-shifted differential signal component 1222, 1224 comprising the delayed transitions. The phase-shifted differential signal components 1222, 1224 are then output by the phase-shifter circuit 1200 as the phase-shifted form of the received differential reference timing signal.

The example phase-shifter circuit 1200 illustrated in FIG. 12 comprises a first delay control component 1242 arranged to receive a first re-timed signal 1252, which in the illustrated example comprises a positive component (Q) of a differential quadrature timing signal such as the (differential) quadrature timing signal 755 output by a 1/M odd numbered frequency divider and re-timing circuit 440, and a second re-timed signal 1254, which in the illustrated example comprises a negative component (I_{b}) of a corresponding differential in-phase timing signal such as the (differential) in-phase timing signal 750 output by the 1/M odd numbered frequency divider and re-timing circuit 440. The first delay control component 1242 is arranged to generate a first delay control signal 1246 provided to the first delay circuit 1232, wherein the amount of delay applied by the first delay circuit 1232 to the transitions within the first differential reference timing signal component 1212 is controllable by the first delay control signal 1246.

The example phase-shifter circuit 1200 illustrated in FIG. 12 further comprises a second delay control component 1244 arranged to receive a third re-timed signal 1256, which in the illustrated example comprises a positive component (I) of the differential in-phase timing signal, and a fourth re-timed signal 1258, which in the illustrated example comprises a negative component (Q_{b}) of the corresponding differential quadrature timing signal. The second delay control component 1244 is arranged to generate a second delay control signal 1248 provided to the second delay circuit 1234, wherein the amount of delay applied by the second delay circuit 1234 to the transitions within the second differential reference timing signal component 1214 is controllable by the second delay control signal 1248.

It will be appreciated that the specific implementation of the delay circuits 1232, 1234 is not limiting on the present invention, and that any controllable delay circuit may be implemented. For completeness however, in the illustrated example each of the delay circuits 1232, 1234 comprises a chain of current-limited inverter delay cells, with the respective delay control signal 1246, 1248 used to control the drain currents of the inverter transistors, and thus the time taken for the inverter to transition between logical states as is well known in the art.

In the example illustrated in FIG. 12, each of the delay control circuits 1232, 1234 is arranged to receive a first re-timed signal comprising a first set of transitions (e.g. rising transitions) re-timed to rising transitions of the reference timing signal and the second set of transitions (e.g. falling) transitions re-timed to rising or falling transitions of the phase-shifted form of the reference timing signal, and a second re-timed signal comprising a first set of transitions (e.g. rising transitions) re-timed to falling transitions of the reference timing signal and the second set of transitions (e.g. falling) transitions re-timed to the same rising or falling transitions of the phase-shifted form of the reference timing signal as the first re-timed signal.

More specifically for the illustrated example, the first delay control circuit 1232 is arranged to receive a first re-timed signal comprising the positive component (Q) 1252 of the differential quadrature timing signal and a the second re-timing signal comprising the negative component (I_{b}) 1254 of the corresponding differential in-phase timing signal and the second delay control circuit 1234 is arranged to receive a third re-timing signal comprising the positive component (I) 1256 of the differential in-phase timing signal and a fourth re-timing signal comprising the negative component (Q_{b}) 1258 of the differential quadrature timing signal.

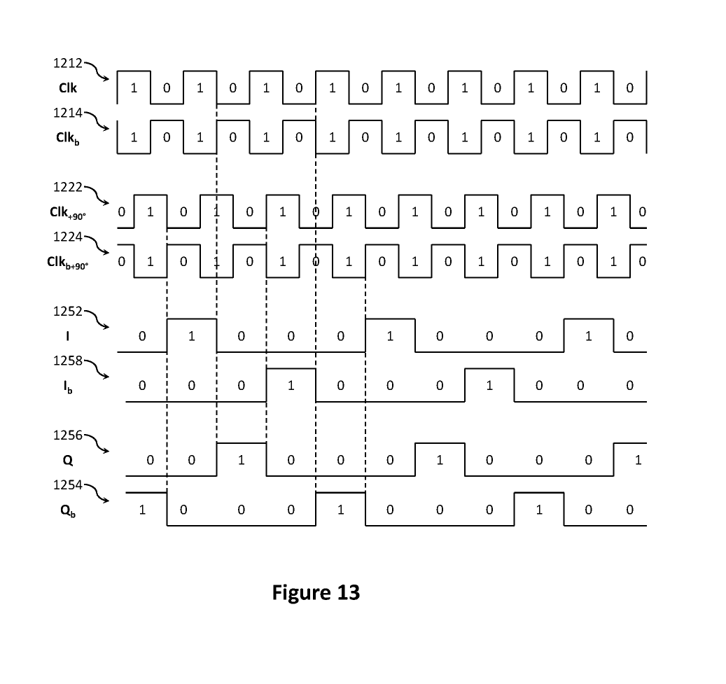

FIG. 13 illustrates a timing diagram showing the various differential signals within FIG. 12 when the phase-shifter circuit is arranged to output a 90° phase-shifted form of the reference timing signal. As illustrated in FIG. 13, the falling transitions of the positive component (Q) 1252 of the differential quadrature timing signal and the rising transitions of the negative component (I_{b}) 1254 of the differential in-phase timing signal are re-timed to rising transitions of the 90° phase-shifted form of the differential reference timing signal (i.e. either the rising transitions of the positive component (Clk_{+90°}) 1222 of the 90° phase-shifted form of the reference timing signal or falling transitions of the negative component (Clk_{b+90°}) 1224 of the 90° phase-shifted form of the reference timing signal). In addition, the rising transitions of the positive component (Q) 1252 of the differential quadrature timing signal are re-timed to falling transitions of the differential reference timing signal (i.e. either the falling transitions of the positive component (Clk) 1212 of the reference timing signal or rising transitions of the negative component (Clk_{b}) 1214 of the reference timing signal), whilst the falling transitions of the negative component (I_{b}) 1254 of the differential in-phase timing signal are re-timed to rising transitions of the differential reference timing signal (i.e. either the rising transitions of the positive component (Clk) 1212 of the reference timing signal or falling transitions of the negative component (Clk_{b}) 1214 of the reference timing signal).

In this manner, the first and second re-timed signals 1252, 1254 provide the first delay control circuit 1242 with a reference of the timing of the rising transitions of the phase-shifted form of the reference timing signal relative to both rising and falling transitions of the reference timing signal. Accordingly, a comparison of the first and second re-timed signals 1252, 1254 enables the accuracy of the rising and falling edges of the positive component (Clk_{+90°}) 1222 of the phase-shifted form of the reference timing signal to be assessed in relation to the rising and falling transitions of the reference timing signal and the first delay control signal 1246 generated accordingly to compensate for asymmetry between the rising and falling edges of the positive component (Clk_{+90°}) 1222 of the phase-shifted form of the reference timing signal caused by PVT variations etc.

As also illustrated in FIG. 13, the rising transitions of the positive component (I) 1256 of the differential in-phase timing signal and the falling transitions of the negative component (Q_{b}) 1258 of the differential quadrature timing signal are re-timed to falling transitions of the 90° phase-shifted form of the differential reference timing signal (i.e. either the falling transitions of the positive component (Clk_{+90°}) 1222 of the 90° phase-shifted form of the reference timing signal or rising transitions of the negative component (Clk_{b+90°}) 1224 of the 90° phase-shifted form of the reference timing signal). In addition, the falling transitions of the positive component (I) 1256 of the differential in-phase timing signal are re-timed to falling transitions of the differential reference timing signal (i.e. either the falling transitions of the positive component (Clk) 1212 of the reference timing signal or rising transitions of the negative component (Clk_{b}) 1214 of the reference timing signal), whilst the rising transitions of the negative component (Q_{b}) 1258 of the differential quadrature timing signal are re-timed to rising transitions of the differential reference timing signal (i.e. either the rising transitions of the positive component (Clk) 1212 of the reference timing signal or falling transitions of the negative component (Clk_{b}) 1214 of the reference timing signal).

In this manner, the third and fourth re-timed signals 1256, 1258 provide the second delay control circuit 1244 with a reference of the timing of the falling transitions of the phase-shifted form of the reference timing signal relative to both rising and falling transitions of the reference timing signal. Accordingly, a comparison of the third and fourth re-timed signals 1256, 1258 enables the accuracy of the rising and falling edges of the negative component (Clk_{b+90°}) 1224 of the phase-shifted form of the reference timing signal to be assessed in relation to the rising and falling transitions of the reference timing signal and the second delay control signal 1248 generated accordingly to compensate for asymmetry between the rising and falling edges of the negative component (Clk_{b+90°}) 1224 of the phase-shifted form of the reference timing signal caused by PVT variations etc.

In the example illustrated in FIG. 12, each delay control circuit 1242, 1244 comprises an operational amplifier 1260 arranged to receive a voltage signal representative of one of the respective re-timed signals 1252, 1256 at a first input thereof and a voltage signal representative of the other of the respective re-timed signals 1254, 1258 at a second input thereof, and each delay control circuit 1242, 1244 is arranged to generate the respective delay control signal 1246, 1248 based on a voltage signal at an output of the respective operational amplifier 1260.

Each delay control circuit further comprises a first input filter circuit 1262 arranged to receive the first of the respective re-timed signals 1252, 1256 and to generate the voltage signal representative thereof at the first input of the operational amplifier 1260 and a second input filter circuit 1264 arranged to receive the second of the respective re-timed signals 1254, 1258 and to generate the voltage signal representative thereof at the second input of the operational amplifier. Each delay control circuit further comprises a capacitance 1266 coupled between the output of the operational amplifier 1260 and a reference voltage node, which in the illustrated example comprises a ground node

Thus, the phase-shifter circuit 1200 of FIG. 12 comprises two delay control loops, one arranged to control the delay applied to the transitions within the first component of the reference timing signal, and thus the timing of the transitions with the first component of the phase-shifted form of the reference timing signal, and the second to control the delay applied to the transitions within the second component of the reference timing signal, and thus the timing of the transitions with the second component of the phase-shifted form of the reference timing signal. In particular, in the example illustrated in FIG. 12 and as described above, the first control loop is responsive to the first and second re-timed signals 1252, 1254, and thus arranged to control the accuracy of the falling transitions of the positive component (Clk₊₉₀°) 1222 of the 90° phase-shifted form of the reference timing signal, whilst the second control loop is responsive to the third and fourth re-timed signals 1256, 1258, and thus arranged to control the accuracy of the falling transitions of the negative component (Clk_{b+90°}) 1224 of the 90° phase-shifted form of the reference timing signal.

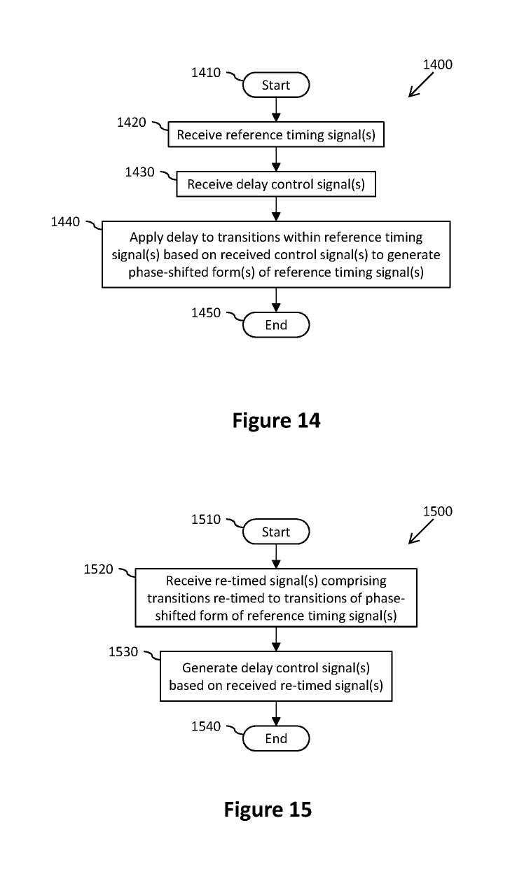

Referring now to FIGS. 14 and 15, there are illustrated simplified flowcharts 1400, 1500 of an example of a method of generating a phase-shifted form of a reference timing signal, such as implemented within the phase-shifter circuit 1200 illustrated in FIG. 12.

A first part of the method starts at 1410 in FIG. 14 and moves on to 1420 where one or more reference timing signals are received, such as the differential reference timing signal 235 in FIGS. 4 and 7 and as represented by the reference timing signal components 1212, 1214 in FIG. 12. One or more delay control signals are received at 1430, such as the delay control signals 1246, 1248 of FIG. 12. A delay is then applied to transitions within the, or each, reference timing signal to generate the phase-shifted form(s) of the reference timing signal at 1440, wherein the amount of delay applied to the transitions within the reference timing signal is controllable by the delay control signal. In the example illustrated in FIG. 12, such delays are applied to each of the differential components 1212, 1214 of the reference timing signal by the delay circuits 1232, 1234. This part of the method then ends, at 1450.

A second part of the method starts at 1520 in FIG. 15 and moves on to 1520 where one or more re-timed signal(s) comprising transitions re-timed to transitions of a phase-shifted form of the reference timing signal are received. In the example illustrated in FIG. 12, such re-timed signals comprise the positive component (Q) 1252 of the differential quadrature timing signal and the negative component (I_{b}) 1254 of the corresponding differential in-phase timing signal (as received by the first delay control circuit), and the positive component (I) 1256 of the differential in-phase timing signal and the negative component (Q_{b}) 1258 of the differential quadrature timing signal (as received by the second delay control circuit). The delay control signal(s) (on which the amount of delay applied to the transitions within the reference timing signal is/are based is based) are then generated at 1530 based on the received re-timed signal(s), for example as described above. The method then ends, at 1540.

Although some aspects of the invention have been described with reference to their applicability to an RF transceiver, for example a transceiver adapted for use within a UMTS (Universal Mobile Telecommunication System) or LTE (Long Term Evolution) cellular communication system, it will be appreciated that the invention is not limited to use within RF transceivers, any may be implemented within any device or system requiring timing signals.

In particular, it is envisaged that the aforementioned inventive concept can be applied by a semiconductor manufacturer to any integrated circuit comprising a synthesizer or other timing signal generation component. It is further envisaged that, for example, a semiconductor manufacturer may employ the inventive concept in a design of a stand-alone device, such as an application-specific integrated circuit (ASIC) and/or any other sub-system element.

It will be appreciated that, for clarity purposes, the above description has described embodiments of the invention with reference to different functional units. However, it will be apparent that any suitable distribution of functionality between different functional units may be used without detracting from the invention. Hence, references to specific functional units are only to be seen as references to suitable means for providing the described functionality, rather than indicative of a strict logical or physical structure or organization.

Aspects of the invention may be implemented in any suitable form including hardware, software, firmware or any combination of these. The invention may optionally be implemented, at least partly, as computer software running on one or more data processors and/or digital signal processors or configurable module components such as FPGA devices. Thus, the elements and components of an embodiment of the invention may be physically, functionally and logically implemented in any suitable way. Indeed, the functionality may be implemented in a single unit, in a plurality of units or as part of other functional units.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term ‘comprising’ does not exclude the presence of other elements or steps.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather indicates that the feature is equally applicable to other claim categories, as appropriate.

Furthermore, the order of features in the claims does not imply any specific order in which the features must be performed and in particular the order of individual steps in a method claim does not imply that the steps must be performed in this order. Rather, the steps may be performed in any suitable order. In addition, singular references do not exclude a plurality. Thus, references to ‘a’, ‘an’, ‘first’, ‘second’, etc. do not preclude a plurality.

Thus, an improved synthesizer and method of operation therefor have been described, wherein the aforementioned disadvantages with prior art arrangements have been substantially alleviated.

We claim:

1. A phase-shifter circuit arranged to receive a reference timing signal and to output at least one phase-shifted form of the reference timing signal; the phase-shifter circuit comprising:
at least one delay circuit arranged to receive the reference timing signal and a delay control signal, and to delay transitions within the reference timing signal to generate the at least one phase-shifted form of the reference timing signal, wherein the amount of delay applied by the delay circuit to the transitions within the reference timing signal is controllable by the delay control signal; and
at least one delay control circuit arranged to receive at least one re-timed signal comprising transitions re-timed to transitions of the phase-shifted form of the reference timing signal output by the phase-shifter circuit, and to generate the delay control signal for the at least one delay circuit based at least partly on the received at least one re-timed signal.

2. The phase-shifter circuit of claim 1, wherein the at least one delay control circuit is arranged to receive at least one re-timed signal comprising further transitions re-timed to transitions of the reference timing signal.

3. The phase-shifter circuit of claim 2, wherein the at least one delay control circuit is arranged to:
receive a first re-timed signal comprising a first set of transitions comprising one of rising and falling transitions and a second set of transitions comprising the other of rising and falling transitions, wherein the first set of transitions of the first re-timed signal are re-timed to rising transitions of the reference timing signal and the second set of transitions of the first re-timed signal are re-timed to one of rising and falling transitions of the phase-shifted form of the reference timing signal;
receive a second re-timed signal comprising a first set of transitions comprising one of rising and falling transitions and a second set of transitions comprising the other of rising and falling transitions, wherein the first set of transitions of the second re-timed signal are re-timed to falling transitions of the reference timing signal and the second set of transitions of the second re-timed signal are re-timed to the same one of rising and falling transitions of the phase-shifted form of the reference timing signal; and
generate the at least one delay control signal based at least partly on the first and second re-timed signals.

4. The phase-shifter circuit of claim 3, wherein the at least one delay control circuit comprises an operational amplifier arranged to receive a voltage signal representative of the first re-timed signal at a first input thereof and a voltage signal representative of the second re-timed signal at a second input thereof, and the at least one delay control circuit is arranged to generate the delay control signal for the at least one delay circuit based at least partly on a voltage signal at an output of the operational amplifier.

5. The phase-shifter circuit of claim 4, wherein the at least one delay control circuit further comprises:
a first input filter circuit arranged to receive the first re-timed signal and to generate the voltage signal representative of the first re-timed signal at the first input of the operational amplifier;
a second input filter circuit arranged to receive the second re-timed signal and to generate the voltage signal representative of the second re-timed signal at the second input of the operational amplifier; and
a capacitance coupled between the output of the operational amplifier and a reference voltage node.

6. The phase-shifter circuit of claim 1, wherein the phase-shifter circuit is arranged to receive a differential reference timing signal and to output a phase-shifted form of the differential reference timing signal; the phase-shifter circuit comprising:
a first delay circuit arranged to receive a first differential component of the reference timing signal and a first delay control signal, and to delay transitions within the first differential component of the reference timing signal to generate a first differential component of the phase-shifted form of the reference timing signal, wherein the amount of delay applied by the first delay circuit to the transitions within the first differential component of the reference timing signal is controllable by the first delay control signal;
a second delay circuit arranged to receive a second differential component of the reference timing signal and a second delay control signal, and to delay transitions within the second differential component of the reference timing signal to generate a second differential component of the phase-shifted form of the reference timing signal, wherein the amount of delay applied by the second delay circuit to the transitions within the second differential component of the reference timing signal is controllable by the second delay control signal;
a first delay control circuit arranged to receive at least one re-timed signal comprising transitions re-timed to transitions of the first differential component of the phase-shifted form of the reference timing signal output by the first phase-shifter circuit, and to generate the first delay control signal for the first delay circuit based at least partly on the at least one re-timed signal received thereby; and
a second delay control circuit arranged to receive at least one re-timed signal comprising transitions re-timed to transitions of the second differential component of the phase-shifted form of the reference timing signal output by the second phase-shifter circuit, and to generate the second delay control signal for the second delay circuit based at least partly on the at least one re-timed signal received thereby.

7. The phase-shifter circuit of claim 6, wherein the first delay control circuit is arranged to:
receive a first re-timed signal comprising a first set of transitions re-timed to rising transitions of the reference timing signal and a second set of transitions re-timed to rising transitions of the first differential component of the phase-shifted form of the reference timing signal;
receive a second re-timed signal comprising a first set of transitions re-timed to falling transitions of the reference timing signal and a second set of transitions re-timed to rising transitions of the first differential component of the phase-shifted form of the reference timing signal; and
generate the first delay control signal based at least partly on the first and second re-timed signals;
and the second delay control circuit is arranged to:
receive a third re-timed signal comprising a first set of transitions re-timed to rising transitions of the reference timing signal and a second set of transitions re-timed to rising transitions of the second differential component of the phase-shifted form of the reference timing signal;
receive a fourth re-timed signal comprising a first set of transitions re-timed to falling transitions of the reference timing signal and a second set of transitions re-timed to falling transitions of the second differential component of the phase-shifted form of the reference timing signal; and
generate the second delay control signal based at least partly on the third and fourth re-timed signals.

8. The phase-shifter circuit of claim 6, wherein:
the first re-timed signal comprises a positive component, Q, of a differential quadrature timing signal;
the second re-timing signal comprises a negative component, I_{b}, of a corresponding differential in-phase timing signal;
the third re-timing signal comprises a positive component, I, of the differential in-phase timing signal; and
the fourth re-timing signal comprises a negative component, Q_{b}, of the differential quadrature timing signal.

9. The phase-shifter circuit of claim 1, arranged to output at least one 90° phase-shifted form of the reference timing signal.

10. A method of generating a phase-shifted form of a reference timing signal, the method comprising:
receiving the reference timing signal;
receiving a delay control signal; and
delaying transitions within the reference timing signal to generate the phase-shifted form of the reference timing signal, wherein the amount of delay applied to the transitions within the reference timing signal is controllable by the delay control signal;
wherein the method further comprises:
receiving at least one re-timed signal comprising transitions re-timed to transitions of the phase-shifted form of the reference timing signal; and
generating the delay control signal for the at least one delay circuit based at least partly on the received at least one re-timed signal.

11. A radio frequency transceiver comprising a synthesizer arranged to generate at least one timing signal; the synthesizer comprising:
at least one odd-numbered frequency divider circuit arranged to receive a reference timing signal and to output at least one frequency-divided signal having a frequency equal to 1/M times the frequency of the reference timing signal, where M is an odd-numbered integer;
the phase-shifter circuit arranged to receive the reference timing signal and to output a 90° phase-shifted form of the reference timing signal; the phase-shifter circuit comprising:
at least one delay circuit arranged to receive the reference timing signal and a delay control signal, and to delay transitions within the reference timing signal to generate the at least one phase-shifted form of the reference timing signal, wherein the amount of delay applied by the delay circuit to the transitions within the reference timing signal is controllable by the delay control signal; and
at least one delay control circuit arranged to receive at least one re-timed signal comprising transitions re-timed to transitions of the phase-shifted form of the reference timing signal output by the phase-shifter circuit, and to generate the delay control signal for the at least one delay circuit based at least partly on the received at least one re-timed signal; and
a re-timing circuit arranged to:
receive the at least one frequency-divided signal;
receive the 90° phase-shifted form of the reference timing signal; and
re-time a set of transitions of the frequency-divided signal to be temporally aligned to transitions of the 90° phase-shifted form of the reference timing signal to generate the at least one timing signal comprising the re-timed transitions of the frequency-divided signal.

12. The radio frequency transceiver of claim 11, wherein the at least one delay control circuit is arranged to receive at least one re-timed signal comprising further transitions re-timed to transitions of the reference timing signal.

13. The radio frequency transceiver of claim 12, wherein the at least one delay control circuit is arranged to:
receive a first re-timed signal comprising a first set of transitions comprising one of rising and falling transitions and a second set of transitions comprising the other of rising and falling transitions, wherein the first set of transitions of the first re-timed signal are re-timed to rising transitions of the reference timing signal and the second set of transitions of the first re-timed signal are re-timed to one of rising and falling transitions of the phase-shifted form of the reference timing signal;
receive a second re-timed signal comprising a first set of transitions comprising one of rising and falling transitions and a second set of transitions comprising the other of rising and falling transitions, wherein the first set of transitions of the second re-timed signal are re-timed to falling transitions of the reference timing signal and the second set of transitions of the second re-timed signal are re-timed to the same one of rising and falling transitions of the phase-shifted form of the reference timing signal; and
generate the at least one delay control signal based at least partly on the first and second re-timed signals.

14. The radio frequency transceiver of claim 23, wherein the at least one delay control circuit comprises an operational amplifier arranged to receive a voltage signal representative of the first re-timed signal at a first input thereof and a voltage signal representative of the second re-timed signal at a second input thereof, and the at least one delay control circuit is arranged to generate the delay control signal for the at least one delay circuit based at least partly on a voltage signal at an output of the operational amplifier.

15. The radio frequency transceiver of claim 24, wherein the at least one delay control circuit further comprises:
a first input filter circuit arranged to receive the first re-timed signal and to generate the voltage signal representative of the first re-timed signal at the first input of the operational amplifier;
a second input filter circuit arranged to receive the second re-timed signal and to generate the voltage signal representative of the second re-timed signal at the second input of the operational amplifier; and
a capacitance coupled between the output of the operational amplifier and a reference voltage node.

16. The radio frequency transceiver of claim 11, wherein the phase-shifter circuit is arranged to receive a differential reference timing signal and to output a phase-shifted form of the differential reference timing signal; the phase-shifter circuit comprising:
a first delay circuit arranged to receive a first differential component of the reference timing signal and a first delay control signal, and to delay transitions within the first differential component of the reference timing signal to generate a first differential component of the phase-shifted form of the reference timing signal, wherein the amount of delay applied by the first delay circuit to the transitions within the first differential component of the reference timing signal is controllable by the first delay control signal;
a second delay circuit arranged to receive a second differential component of the reference timing signal and a second delay control signal, and to delay transitions within the second differential component of the reference timing signal to generate a second differential component of the phase-shifted form of the reference timing signal, wherein the amount of delay applied by the second delay circuit to the transitions within the second differential component of the reference timing signal is controllable by the second delay control signal;
a first delay control circuit arranged to receive at least one re-timed signal comprising transitions re-timed to transitions of the first differential component of the phase-shifted form of the reference timing signal output by the first phase-shifter circuit, and to generate the first delay control signal for the first delay circuit based at least partly on the at least one re-timed signal received thereby; and
a second delay control circuit arranged to receive at least one re-timed signal comprising transitions re-timed to transitions of the second differential component of the phase-shifted form of the reference timing signal output by the second phase-shifter circuit, and to generate the second delay control signal for the second delay circuit based at least partly on the at least one re-timed signal received thereby.

17. The radio frequency transceiver of claim 16, wherein the first delay control circuit is arranged to:
receive a first re-timed signal comprising a first set of transitions re-timed to rising transitions of the reference timing signal and a second set of transitions re-timed to rising transitions of the first differential component of the phase-shifted form of the reference timing signal;
receive a second re-timed signal comprising a first set of transitions re-timed to falling transitions of the reference timing signal and a second set of transitions re-timed to rising transitions of the first differential component of the phase-shifted form of the reference timing signal; and
generate the first delay control signal based at least partly on the first and second re-timed signals;
and the second delay control circuit is arranged to:
receive a third re-timed signal comprising a first set of transitions re-timed to rising transitions of the reference timing signal and a second set of transitions re-timed to rising transitions of the second differential component of the phase-shifted form of the reference timing signal;
receive a fourth re-timed signal comprising a first set of transitions re-timed to falling transitions of the reference timing signal and a second set of transitions re-timed to falling transitions of the second differential component of the phase-shifted form of the reference timing signal; and
generate the second delay control signal based at least partly on the third and fourth re-timed signals.

18. The radio frequency transceiver of claim 16, wherein:
the first re-timed signal comprises a positive component, Q, of a differential quadrature timing signal;
the second re-timing signal comprises a negative component, I_{b}, of a corresponding differential in-phase timing signal;
the third re-timing signal comprises a positive component, I, of the differential in-phase timing signal; and
the fourth re-timing signal comprises a negative component, Q_{b}, of the differential quadrature timing signal.
